(19) United States
(12) Patent Application Publication
(10) Pub. No.: US 2011/0121836 A1
(43) Pub. Date: May 26, 2011

(54) METHOD OF CONTROLLING SECONDARY BATTERY

(75) Inventors: Beomgyu Kim, Yongin-si (KR); Susumu Segawa, Yongin-si (KR); Testuya Okada, Yongin-si (KR); Euijeong Hwang, Yongin-si (KR); Sesub Sim, Yongin-si (KR); Jongwoon Yang, Yongin-si (KR)

(73) Assignee: Samsung SDI Co., Ltd., Yongin-si (KR)

(21) Appl. No.: 12/953,989

(22) Filed: Nov. 24, 2010

(30) Foreign Application Priority Data
Nov. 24, 2009 (KR) 10-2009-0113891

(51) Int. Cl. G01N 27/416

(52) U.S. Cl. 324/433

(57) ABSTRACT

A method of controlling a secondary battery is disclosed. The method includes repeatedly disconnecting and connecting the secondary battery and a load as a result of a sensed current being greater than a maximum load current value, and maintaining the connected or the disconnected state according to a comparison of a second sensed current and the maximum load current value.

### CROSS-REFERENCE TO RELATED APPLICATION

This application claims priority to and the benefit of Korean Patent Application No. 10-2009-0113891 filed on Nov. 24, 2009, the entire content of which is incorporated herein by reference.

### BACKGROUND

1. Field

The field relates to a secondary battery.

2. Description of the Related Technology

As communication and computer industries are rapidly developed, portable electric tools have come into wide use. Rechargeable secondary battery packs are typically used for power supply of the portable electric tools.

Motors of the portable electric tools are driven by electric power provided by the secondary battery pack. These secondary battery packs generally include a bare cell, a controlling unit for providing voltage information of the bare cell, and a switching unit for supplying a current from the bare cell to the electric tool.

### SUMMARY OF CERTAIN INVENTIVE ASPECTS

One aspect is a method of controlling a secondary battery. The method includes a sampling operation measuring a first current value by sampling a current from the secondary battery, a first load current condition determining operation comparing a maximum load current value of a controlling unit of the secondary battery with the first current value, a switch driving operation turning on and off a switch of the second battery as a result of the first current value being greater than the maximum load current, and a second load current condition determining operation comparing a second current value of the switch driving operation with the first current value.

Another aspect is a method of controlling a secondary battery driving a load. The method includes measuring a first current value from the secondary battery, comparing the first current value to a maximum load current value, disconnecting the load from the secondary battery as a result of the first current value being greater than the maximum load current, connecting the load to the secondary battery, measuring a second current value from the secondary battery subsequent to connecting the load, comparing the second current value to the first current value, maintaining the connection of the secondary battery and the load as a result of the second current value being less than the first current value, and disconnecting the secondary battery and the load as a result of the second current value being greater than or equal to the first current value.

Another aspect includes an electric tool system. The system includes a battery, a load for the battery, a switching unit, and a current detecting unit, configured to sense current from the battery to the load. The system also includes a controlling unit, configured to generate a control signal for the switching unit according to a comparison of the sensed current of the current detecting unit and a maximum load current value, wherein the switching unit is configured to selectively connect the secondary battery to the load according to the control signal, and wherein the controlling unit is configured to generate the control signal so as to repeatedly disconnect and connect the battery and the load as a result of the sensed current being greater than the maximum load current value, and to maintain the connected or the disconnected state according to a comparison of a second sensed current of the current detecting unit and the maximum load current value.

### BRIEF DESCRIPTION OF THE DRAWINGS

The above and other features and advantages will become more apparent to those of ordinary skill in the art through the description of certain exemplary embodiments with reference to the attached drawings, in which:

FIG. 1 is a block diagram illustrating a secondary battery controlling system used for a method of controlling a secondary battery;

FIG. 2 is a flowchart illustrating a method of controlling a secondary battery according to one embodiment;

FIGS. 3A and 3B are graphs illustrating a current change and an operation of a switching unit according to a secondary battery controlling system; and

FIGS. 4A and 4B are graphs illustrating a current change and an operation of a switching unit according to a secondary battery controlling system.

### DETAILED DESCRIPTION OF CERTAIN INVENTIVE EMBODIMENTS

Example embodiments will now be described more fully hereinafter with reference to the accompanying drawings; however, these embodiments may be embodied in different forms. Rather, these embodiments are provided so that this disclosure will be thorough and complete.

Hereinafter, embodiments will be described in detail with reference to the accompanying drawings.

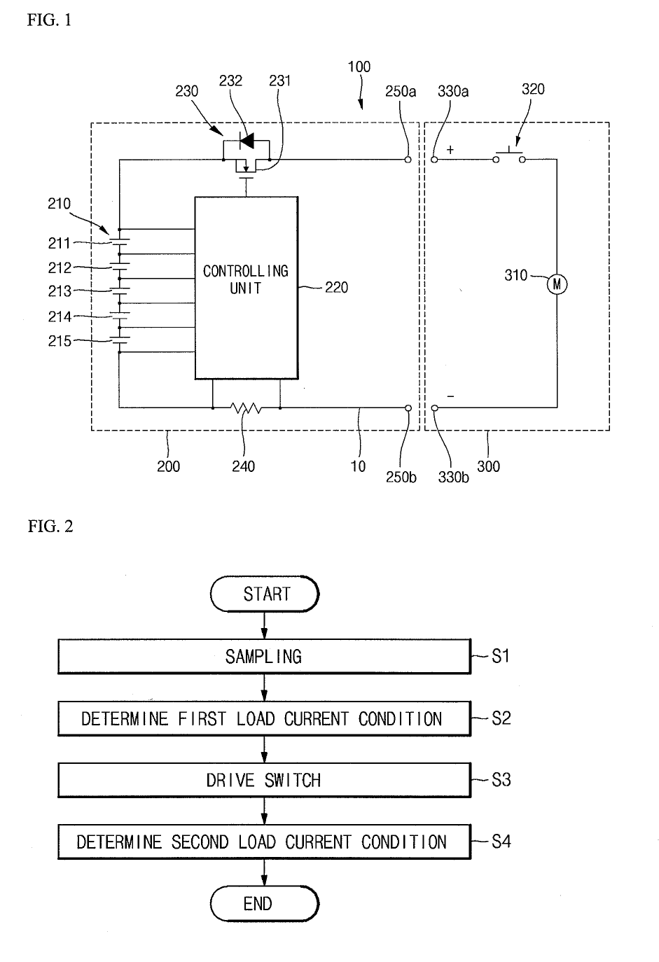

FIG. 1 is a block diagram illustrating a secondary battery controlling system used for a method of controlling a secondary battery according to one embodiment.

As shown in FIG. 1, an electric tool system 100 using a secondary battery includes a secondary battery pack 200, and an electric tool 300 equipped with the secondary battery pack 200.

The secondary battery pack 200 includes a bare cell 210, a controlling unit 220, a switching unit 230, a current detecting unit 240, and external terminals 250a and 250b.

The bare cell 210 stores electric energy and includes a positive pole and a negative pole. The bare cell 210 may be, for example, a lithium ion battery or a lithium polymer battery. Here, the bare cell 210 includes five bare cells, or secondary batteries, that is, first to fifth bare cells 211 to 215.

The first bare cell 211 has a positive pole that is electrically connected to the switching unit 230 and the controlling unit 220. The first bare cell 211 has a negative pole that is electrically connected to a positive pole of the second bare cell 212. The negative pole of the first bare cell 211 and the positive pole of the second bare cell 212 are electrically connected to the same terminal of the controlling unit 220. The other bare cells 212-215 are similarly connected, as shown in FIG. 1

The bare cell 210 includes the five secondary batteries and supplies electric energy to the controlling unit 220. Additionally, although the bare cell 210 includes the five secondary batteries in FIG. 1, the number of bare cells 210 is not restricted thereto.

Additionally, the bare cell 210 may be, for example, configured with a cylinder type secondary battery.

The controlling unit 220 may be one of various kinds of micro computers manufactured for a lithium ion battery. The controlling unit 220 provides a control signal corresponding to data (e.g., voltage information of the bare cell 210) processed by a program or an algorithm, to the switching unit 230. The controlling unit 220 includes a central processing unit for performing a method according to various embodiments and a memory where various programs and parameters are stored.

The controlling unit 220 is electrically connected to a Field-Effect Transistor (FET) 231 of the switching unit 230 and the current detecting unit 240. The controlling unit 220 receives a power supply from the bare cell 210 and controls an operation of the switching unit 230.

The controlling unit 220 applies a gate voltage to a gate terminal of the FET 231 of the switching unit 230 in order to turn on the switching unit 230 when the electric tool 300 is to be turned on. The controlling unit 220 continuously receives a current value detected by the current detecting unit 240 when a voltage is applied. If the received current value is less than a maximum load current value set by the controlling unit 220, the switching unit 230 maintains a turned on state. Accordingly, current from the bare cell 210 is continuously delivered to the electric tool 300 along a high current path 10. In various embodiments, the maximum load current value is the maximum allowable load current value of a motor 310 of the electric tool 300.

If the received current value is greater than the maximum load current value set by the controlling unit 220, the switching unit 230 is turned off. Accordingly, current of the bare cell 210 does not flow to the electric tool 300. Accordingly, when the motor 310 stops and the load increases, excessive current draw from the bare cell 210 is prevented.

The controlling unit 220 may use, for example, an operational amplifier to determine when a current value flowing through the high current path 10 is greater than the maximum load current value.

The switching unit 230 includes the FET 231 and a parasite diode 232 in parallel with the FET 231. The FET 231 has a drain and a source, which are on the high current path 10 of the bare cell 210.

The FET 231 receives a control signal from the controlling unit 220 to the gate and is turned on or off according to the control signal. The FET 231 serves to apply a current of the bare cell 210 to the electric tool 300 through the positive terminal 250a and the negative terminal 250b when the electric tool 300 is turned on.

The parasite diode 232 is configured with an inverse direction with respect to a current direction. The parasite diode 232 provides a current path when the FET 232 is turned off.

The switching unit 230 may use another transistor or other non-contact switches. Additionally, the switching unit 230 may use contact switches such as a relay or a lead switch.

The switching unit 230 supplies a current from the bare cell 210 to the electric tool 300. The switching unit 230 is turned on when a current flowing through the high current path 10 is less than the predetermined maximum load current value of the controlling unit 220. On the contrary, when a current flowing through the high current path 10 is not less than the maximum load current value, the switching unit 230 is turned off.

The current detecting unit 240 is on the high current path 10. The current detecting unit 240 has both ends that are electrically connected to the controlling unit 220. In this embodiment, the current detecting unit 240 includes a sense resistor.

The external terminals 250a and 250b include the positive terminal 250a and the negative terminal 250b. The positive terminal 250a and the negative terminal 250b are electrically and respectively connected to the bare cell 210 on the high current path 10.

The electric tool 300 includes a motor 310, a switching device 320, and device terminals 330a and 330b. The motor 310 has one end that is electrically connected to the switching device 320 and has the other end that is electrically connected to the negative terminal 330b of the device terminals 330a and 330b. The motor 310 is driven by a voltage applied from the bare cell 210. The motor 310 rotates with a high speed under a no load state when a voltage is applied. However, if rotation of the motor 310 stops compulsorily, a load of the electric tool 300 is increased. Accordingly, a discharge current is increased. If, for example, rotation of the motor 310 stops completely, a discharge current becomes greater than the maximum.

The switching device 320 accordingly turns on or off a current flowing through the electric tool 300.

The switching device 320 is a device that can be manually turned on or off by an operator to drive the electric tool 300. Accordingly, if the switching device 320 is turned off, the supplied current is cut off such that it is not supplied to the motor 310. Accordingly, the motor 310 does not operate.

The electrode terminals 330a and 330b include the positive terminal 330a and the negative terminal 330b. The positive terminal 330a is electrically connected to the switching device 320. Additionally, the negative terminal 330b is electrically connected to the motor 310.

The electrode terminals 330a and 330b are respectively connected to the external terminals 250a and 250b of the secondary battery pack 200 to form a current path. Accordingly, a current of the bare cell 210 is supplied to the motor 310.

Next, a method of controlling a secondary battery will be described according to one embodiment.

FIG. 2 is a flowchart illustrating a method of controlling a secondary battery according to one embodiment of the present invention.

As shown in FIG. 2, the method of controlling a secondary battery includes a sampling operation S1, a first load current condition determining operation S2, a switch driving operation S3, and a second load current condition determining operation S4. At this point, configuration for a secondary battery system refers to FIG. 1.

First, during the sampling operation S1 a first current value is measured by sampling a current from the secondary battery pack 200 over a certain time interval.

In order to perform the sampling operation S1, the current detecting unit 240 generates a first voltage value on the high current path 10 representing the current. The generated first voltage is transferred to the controlling unit 220.

Next, during the first load current condition determining operation S2 the maximum load current value set by the controlling unit 220 is compared with the first current value sampled during the sampling operation S1. The maximum load current value is the maximum desired load current value for the motor 310. The maximum load current value is reached when rotation of the motor 310 stops.

Next, during the switch driving operation S3, current flowing into the motor 310 is adjusted by turning on or off the switching unit 230. If the first current value is less than the maximum load current value, the switching unit 230 maintains a turned on state. Accordingly, current of the secondary battery pack 200 continuously flows through the motor 310 of the electric tool 300.

However, if the first current value reaches the maximum load current value, the switching unit 230 is turned off. This is for reducing a current flowing through the motor 310. In some embodiments, the switching unit 230 is turned off for a period of time and subsequently turned on again. In some embodiments, the switching unit 230 is repeatedly turned off and on with a constant or a changing period.

Next, during the second load current condition determining operation S4 a second current value is compared with the first current value. The second current is measured after the switching unit 230 is turned on. If the second current value is less than the first current value, the switching unit 230 maintains a turned on state. This means that a current value flowing into the motor 310 is decreased during the switch driving operation S3.

However, if the second current value is not less than the first current value, the switching unit 230 maintains a turned off state. This means that a current value flowing into the motor 310 is not decreased even during the switch driving operation S3, that is, the current value reaches the maximum discharge current value despite the interruption in current. Accordingly, even if the switching device 320 of the electric tool 300 is turned on, a current does not flow into the motor 310 because the switching unit 230 is off. Accordingly, power consumption due to load increase can be reduced.

A current change of the secondary battery system will be described according to one embodiment.

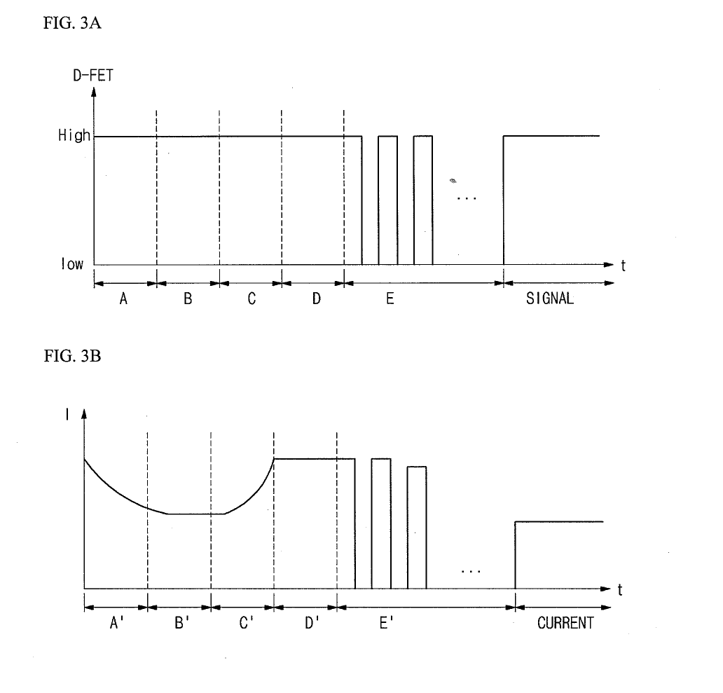

FIG. 3A is a graph illustrating the control signal when the switching unit 230 is turned on and off. The x-axis of FIG. 3A represents time and the y-axis of FIG. 3A represents the control signal for the switching unit 230.

Additionally, FIG. 3B is a graph illustrating the secondary battery current when the switching unit 230 is turned on and off. The x-axis of FIG. 3B represents time and the y-axis of FIG. 3B represents current from the secondary battery.

During intervals A to D of FIG. 3A the switching device 320 is turned on. The current is shown in corresponding intervals A′ to D′ intervals of FIG. 3B.

During the A/A′ interval, the motor 310 is turned on. Initially, the motor 310 is stopped and the current is at a high value. As the motor 310 accelerates, the current drops from an initial high level toward an operating level.

During the B/B′ interval, the motor 310 reaches the operating speed and the current is stable.

During the C/C′ interval, the motor is slowed by an external force or mechanical load. As the motor 310 slows, the current increases.

During the D/D′ interval, the motor 310 is stopped. Accordingly, current of the motor 310 is at a maximum level.

During the E/E′ interval, the switching unit 230 is turned on and off to try to reduce the current flowing through the motor 310 when on. In this example, each time the switching unit 230 is turned on the amount of current is less.

Once the current reaches the operating level, the switching unit 230 is turned on and remains on. In this embodiment, the switching unit 230 is periodically turned on and off in FIG. 3A, but the operation may be non-periodical.

Next, another current change of the secondary battery system will be described according to an embodiment.

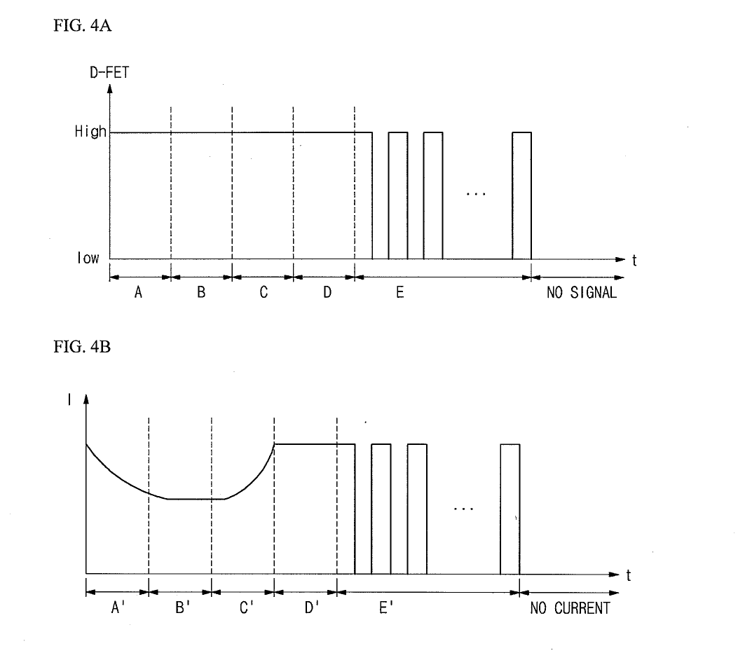

FIG. 4A is a graph illustrating the secondary battery current when the switching unit 230 is turned on and off. The x-axis of FIG. 4A represents time and a y-axis of FIG. 4A represents the control signal of the switching unit 230.

FIG. 4B is a graph illustrating the secondary battery current when the switching unit 230 is turned on and off. The x-axis of FIG. 4B represents time and a y-axis of FIG. 4B represents the current of the secondary battery.

Differences between FIGS. 4A and 4B and FIGS. 3A and 3B will be described.

During the E/E′ interval, the switching unit 230 is turned on and off to try to reduce the current flowing through the motor 310 when on. In this example, each time the switching unit 230 is turned on the amount of current is not less.

Because the current does not reduce, the switching unit 230 is turned off and remains off. In this embodiment, the switching unit 230 is periodically turned on and off in FIG. 3A, but the operation may be non-periodical.

According to the method, a current of a battery pack is adjusted by controlling an operation of the switching device of the secondary battery. As a result, usage time is increased.

The method includes adjusting a current of a battery pack by controlling an operation of a switching device and results in increased efficiency of the battery pack.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention.

What is claimed is:

1. A method of controlling a secondary battery, the method comprising:
a sampling operation measuring a first current value by sampling a current from the secondary battery;
a first load current condition determining operation comparing a maximum load current value of a controlling unit of the secondary battery with the first current value;
a switch driving operation turning on and off a switch of the second battery as a result of the first current value being greater than the maximum load current; and
a second load current condition determining operation comparing a second current value of the switch driving operation with the first current value.

2. The method as claimed in claim 1, wherein the maximum load current value is the maximum allowable load current value of a motor of an electric tool connected to the secondary battery.

3. The method as claimed in claim 1, wherein the switch driving operation turns the switch on and off periodically.

4. The method as claimed in claim 1, wherein the switch driving operation turns the switch on and off non-periodically.

5. The method as claimed in claim 1, wherein the switch driving operation turns on the switch continuously as a result of the first current value being less than the maximum load current value.

6. The method as claimed in claim 1, wherein the switch driving operation repeatedly turns the switch on and off as a result of the first current value being greater than the maximum load current value.

7. The method as claimed in claim 1, wherein the second load current condition determining operation maintains a turned on state of the switch as a result of the second current value being less than the first current value.

8. The method as claimed in claim 1, wherein the second load current condition determining operation maintains a turned on state of the switch as a result of the second current value reaching an operating value.

9. The method as claimed in claim 1, wherein the second load current condition determining operation turns off the switch as a result of the second current value being greater than the first current value.

10. The method as claimed in claim 1, wherein the second load current condition determining operation turns off the switch as a result of the second current value being greater than the maximum load current value.

11. A method of controlling a secondary battery driving a load, the method comprising:
measuring a first current value from the secondary battery;
comparing the first current value to a maximum load current value;
disconnecting the load from the secondary battery as a result of the first current value being greater than the maximum load current;
connecting the load to the secondary battery;
measuring a second current value from the secondary battery subsequent to connecting the load;
comparing the second current value to the first current value; and
maintaining the connection of the secondary battery and the load as a result of the second current value being less than the first current value, and disconnecting the secondary battery and the load as a result of the second current value being greater than or equal to the first current value.

12. The method as claimed in claim 11, further comprising re-disconnecting and re-connecting the load to the secondary battery after connecting the load and prior to measuring the second current value.

13. The method as claimed in claim 11, further comprising repeatedly disconnecting and connecting the load to the secondary battery prior to measuring the second current value.

14. The method as claimed in claim 11, further comprising periodically disconnecting and connecting the load to the secondary battery prior to measuring the second current value.

15. The method as claimed in claim 11, further comprising non-periodically disconnecting and connecting the load to the secondary battery prior to measuring the second current value.

16. The method as claimed in claim 11, further comprising maintaining the connection of the secondary battery and the load as a result of the second current value reaching an operating value.

17. An electric tool system, comprising:
a battery;
a load for the battery;
a switching unit;
a current detecting unit, configured to sense current from the battery to the load; and
a controlling unit, configured to generate a control signal for the switching unit according to a comparison of the sensed current of the current detecting unit and a maximum load current value, wherein the switching unit is configured to selectively connect the secondary battery to the load according to the control signal, and wherein the controlling unit is configured to generate the control signal so as to repeatedly disconnect and connect the battery and the load as a result of the sensed current being greater than the maximum load current value, and to maintain the connected or the disconnected state according to a comparison of a second sensed current of the current detecting unit and the maximum load current value.

18. The system of claim 17, wherein the battery comprises a plurality of bare cells.

19. The system of claim 17, wherein the load comprises a motor.

20. The system of claim 17, wherein the controlling unit is configured to generate the control signal so as to periodically disconnect and connect the battery.
